(19) United States
(12) Patent Application Publication
(10) Pub. No.: US 2026/0124855 A1
(43) Pub. Date: May 7, 2026

(54) WHEEL MOUNTING STRUCTURE FOR VEHICLE

(71) Applicants: Hyundai Motor Company, Seoul (KR); Kia Corporation, Seoul (KR); Seohan Innobility., Ltd., Jincheon-gun (KR)

(72) Inventors: Ju Ho KIM, Hwaseong-Si (KR); Eun Sik Kim, Hwaseong-Si (KR); Hyun Soo Kim, Hwaseong-Si (KR); Young Seung Yu, Hwaseong-Si (KR); Ki Jeong Kim, Hwaseong-Si (KR)

(73) Assignees: Hyundai Motor Company, Seoul (KR); Kia Corporation, Seoul (KR); Seohan Innobility., Ltd., Jincheon-gun (KR)

(21) Appl. No.: 19/201,176

(22) Filed: May 7, 2025

(30) Foreign Application Priority Data
Nov. 6, 2024 (KR) 10-2024-0156399

(51) Int. Cl. B60B 3/16; B60B 3/18; B60B 29/00

(52) U.S. Cl. CPC B60B 3/165; B60B 3/18; B60B 29/00; B60B 2900/111

(57) ABSTRACT

A wheel mounting structure for a vehicle includes a wheel hub, a wheel fitted around a center boss of the wheel hub at an internal diameter portion of the wheel, a center lock bolt coupled to the center boss and configured to press the internal diameter portion of the wheel against a hub flange of the wheel hub, and a latch mounted between the center lock bolt and the center boss and configured to lock the center lock bolt in the center boss.

### CROSS-REFERENCE TO RELATED APPLICATION

The present application claims priority to Korean Patent Application No. 10-2024-0156399 filed on Nov. 6, 2024, the entire contents of which is incorporated herein for all purposes by this reference.

### BACKGROUND OF THE PRESENT DISCLOSURE

### Field of the Present Disclosure

The present disclosure relates to technology for mounting a wheel of a vehicle to a wheel hub.

### Description of Related Art

A vehicle is configured to transmit drive force to tires thereof on a road surface, and accordingly, includes a structure configured to mount each tire to a wheel and to mount the wheel to the vehicle, to mount the tire to the vehicle.

The wheel is mounted to a wheel hub of the vehicle. For stable power transmission performance and better durability of the vehicle, a firm mounting structure is required between the wheel and the wheel hub.

In conventional cases, a structure configured to fix a wheel to a wheel hub using a plurality of hub bolts and a plurality of wheel nuts is widely used. This structure provides very strong coupling and high durability.

However, the wheel mounting structure using the plurality of hub bolts and the plurality of wheel nuts has drawbacks in that a relatively long time to replace the wheel is consumed, and the appearance of the wheel mounting structure is somewhat poor.

In keeping with recent increase in popularity of high-performance vehicles and recent advances in motor sports, a further reduced time to replace the wheel and a more aesthetically pleasing and elegant wheel appearance are required.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a wheel mounting structure for a vehicle which is configured for greatly reducing a wheel replacement time and effectively preventing theft of a wheel while being advantageous in terms of formation of an aesthetically pleasing and elegant wheel appearance.

Objects of the present disclosure are not limited to the above-described object, and other objects of the present disclosure not yet described will be more clearly understood by those skilled in the art from the following detailed description.

In accordance with an aspect of the present disclosure, the above and other objects may be accomplished by the provision of a wheel mounting structure for a vehicle including a wheel hub, a wheel fitted around a center boss of the wheel hub at an internal diameter portion of the wheel, a center lock bolt coupled to the center boss and configured to press the internal diameter portion of the wheel against a hub flange of the wheel hub, and a latch mounted between the center lock bolt and the center boss and configured to lock the center lock bolt in the center boss.

The latch may be mounted to release a locked state of the center lock bolt by a pressure applied to the latch through the center lock bolt.

The latch may be mounted at the center boss to be linearly slidable in an axial direction while being prevented from rotating, and may be supported by the wheel hub while being elastically supported against the center lock bolt in the axial direction.

Latch teeth may be formed at facing surfaces of the latch and the center lock bolt to allow rotation of the center lock bolt in a fastening direction of the center lock bolt to the center boss while preventing rotation of the center lock bolt in a direction opposite to the fastening direction.

A spring seat may be provided at the wheel hub. A spring may be mounted between the spring seat and the latch to elastically support the latch against the center lock bolt.

A hub cavity may be formed at the wheel hub to reduce a mass of the wheel hub. The spring seat may be supported by a snap ring mounted between the hub cavity and the center boss.

A circlip may be mounted at the wheel hub to prevent the latch elastically supported by the spring from being separated from the wheel hub.

A pressing ring including a wedge-shaped cross-section may be provided between a head flange of the center lock bolt and the wheel to press the wheel against the hub flange.

The wedge-shaped cross-section of the pressing ring may include an inclined ring surface formed to be inclined with respect to the axial direction to contact with the wheel, an internal circumferential ring surface configured to enclose the center boss of the wheel hub, and a bolt facing surface formed to be perpendicular to the axial direction so that the bolt facing surface faces the head flange of the center lock bolt.

A friction reducing washer may be located between the bolt facing surface of the pressing ring and the head flange of the center lock bolt to reduce friction therebetween.

At least one friction reducing groove may be formed at the head flange facing the friction reducing washer to reduce an area of the head flange contacting with the friction reducing washer.

A seal ring may be provided at a circumferential surface of the head flange of the center lock bolt to form a seal between the head flange and the wheel.

Tool engagement grooves and protrusions may be radially regularly formed at the head flange of the center lock bolt in a direction toward a predetermined tool so that the tool engagement grooves and protrusions are disposed along a circumference of the head flange, to enable the head flange to receive rotation force from the predetermined tool in a state in which the predetermined tool applies a pressure for releasing the latch through a tool insertion hole formed at a center portion of the center lock bolt.

A center cap may be mounted to the center lock bolt to seal the tool insertion hole.

At least one stud may be mounted at the hub flange of the wheel hub while protruding to be inserted into a wheel hub groove of the wheel.

The stud may include a stud bolt fastened to the hub flange, and a stud sleeve formed to contact with the wheel hub groove and to allow the stud bolt to extend therethrough. The stud sleeve may be formed of a material different from a material of the stud bolt.

A brake disc may be mounted between the wheel hub and the wheel. The stud sleeve may have a greater diameter at a portion thereof inserted into the wheel hub groove than at a portion thereof extending through the brake disc, to press the brake disc against the wheel hub by a pressure applied by the stud bolt, fixing the brake disc to the wheel hub.

In accordance with another aspect of the present disclosure, there is provided a wheel hub assembly for a vehicle including a hub flange including a flat surface perpendicular to an axial direction, a center boss protruding from the hub flange in the axial direction, a center lock bolt fastened to the center boss and configured to press, against the hub flange, an internal diameter portion of a wheel fitted around the center boss, and a latch configured to be linearly slidable in the axial direction within the center boss while being prevented from rotating, to lock the center lock bolt for prevention of rotation of the center lock bolt with respect to the center boss.

At least one stud protruding in the axial direction may be mounted at the hub flange. The latch may be configured to release a locked state of the center lock bolt by an axial pressure of a tool inserted into the center lock bolt through a center portion of the center lock bolt.

In accordance with another aspect of the present disclosure, there is provided a wheel for a vehicle including an internal diameter portion configured to be fitted around a center boss protruding along a rotation center of a hub flange in an axial direction, to couple the wheel to a wheel hub including the center boss, the wheel hub further including a stud spaced apart from the center boss while protruding from the hub flange in the axial direction, and a wheel hub groove formed at an area surrounding the internal diameter portion to receive the stud, wherein the area surrounding the internal diameter portion is formed to be pressed against the hub flange by a center lock bolt coupled to the center boss.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a partially-broken perspective view showing a wheel mounting structure for a vehicle according to an exemplary embodiment of the present disclosure;

FIG. 2 is a sectional view showing an essential portion of FIG. 1;

FIG. 3 is an exploded perspective view showing the essential portion of FIG. 1;

FIG. 4 is a view explaining a state of a predetermined tool inserted into an essential portion of FIG. 2;

FIG. 5 is a sectional view explaining an internal structure of a wheel hub of FIG. 2;

FIG. 6 is a cross-sectional view taken along line F6-F6 in FIG. 4;

FIG. 7 is a view showing an example in which latch teeth are formed at facing surfaces of a center lock bolt and a latch;

FIG. 8 is a view explaining structures of the center lock bolt and a pressing ring;

FIG. 9 is a view explaining a state in which a friction reducing washer is mounted at the center lock bolt;

FIG. 10 is a view exemplarily illustrating a state in which the friction reducing washer is removed from the center lock bolt, and a friction reducing groove is exposed.

FIG. 11 is a view exemplarily illustrating the predetermined tool configured to fasten and release the center lock bolt of the present disclosure;

FIG. 12 is a view showing the center lock bolt;

FIG. 13 is a view explaining a procedure for inserting the predetermined tool into the center lock bolt;

FIG. 14 is a view showing a state before the predetermined tool presses the latch;

FIG. 15 is a view exemplarily illustrating a state in which the predetermined tool is inserted into the center lock bolt, releases the latch, and applies rotation force to rotate the center lock bolt;

FIG. 16 is a view showing a state in which the latch locks the center lock bolt to prevent rotation of the center lock bolt in the state of FIG. 14;

FIG. 17 is a view showing a state in which the latch releases a locked state of the center lock bolt from the state of FIG. 15;

FIG. 18 is a view explaining a coupling structure between a plurality of studs mounted at the wheel hub and a wheel; and

FIG. 19 is a view exemplarily illustrating a cross-section of the wheel coupled to the studs.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

In the following description of the exemplary embodiments of the present disclosure, a detailed description of known technologies incorporated herein will be omitted when it may obscure the subject matter of the exemplary embodiments of the present disclosure. Furthermore, the exemplary embodiments of the present disclosure will be more clearly understood from the accompanying drawings and should not be limited by the accompanying drawings, and it is to be appreciated that all changes, equivalents, and substitutes that do not depart from the spirit and technical scope of the present disclosure are encompassed in the present disclosure.

It will be understood that, although the terms “first”, “second”, etc. may be used herein to describe various elements, these elements should not be limited by these terms. These terms are only used to distinguish one element from another.

Unless clearly used otherwise, singular expressions include a plural meaning.

In the present specification, the term “comprising”, “including”, or the like, is intended to express the existence of the characteristic, the numeral, the step, the operation, the element, the part, or the combination thereof, and does not exclude another characteristic, numeral, step, operation, element, part, or any combination thereof, or any addition thereto.

Any number of components or a variety of components of any one of the configurations disclosed in the present disclosure may be included in the present disclosure. Such components may include any combination of characterized parts disclosed in the present disclosure, and may be arranged to constitute any one of various configurations disclosed in the present disclosure. Not only structures and arrangements of the components of the present disclosure, but also concepts as to use and operation thereof, may be applied not only to various exemplary embodiments discussed in the present disclosure, but also to exemplary embodiments of any numbers and in any combinations. In the following description, various exemplary embodiments including various characterized parts having various arrangements will be described with reference to the accompanying drawings.

Hereinafter, various embodiments included in the present disclosure will be described in detail with reference to the accompanying drawings, and the same or similar elements are designated by the same reference numerals regardless of the numerals in the drawings and redundant description thereof will be omitted.

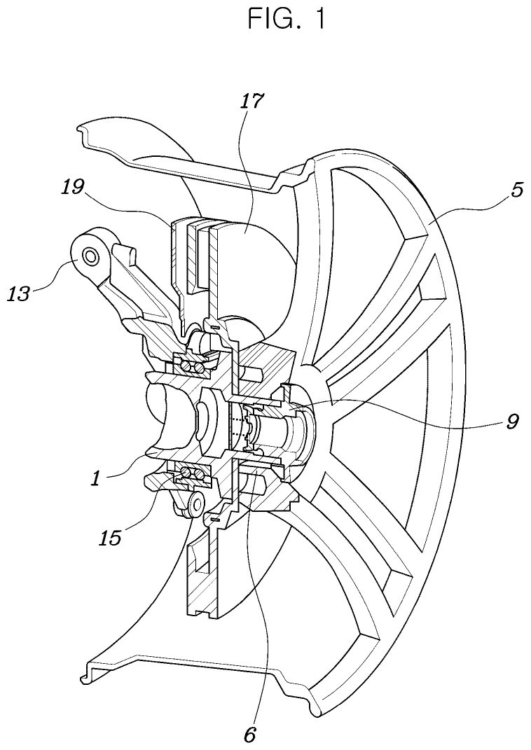

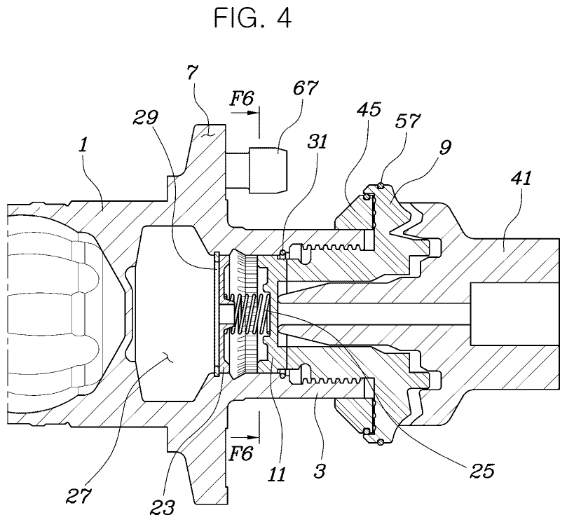

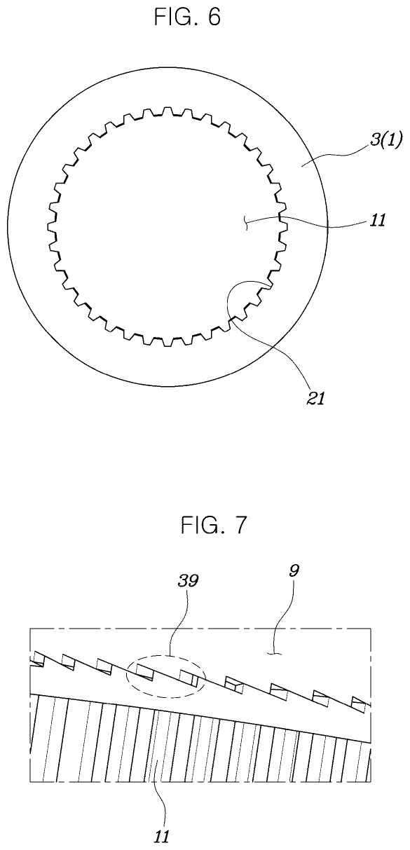

Referring to FIGS. 1 to 19, an exemplary embodiment of a wheel mounting structure for a vehicle in an exemplary embodiment of the present disclosure includes a wheel hub 1, a wheel 5 fitted around a center boss 3 of the wheel hub 1, a center lock bolt 9 coupled to the center boss 3 and configured to press an internal diameter portion 6 of the wheel 5 against a hub flange 7 of the wheel hub 1, and a latch 11 configured to lock the center lock bolt 9 in the center boss 3.

That is, in an exemplary embodiment of the present disclosure, when the center lock bolt 9 is coupled to the center boss 3 in a state in which the internal diameter portion 6 centrally formed at the wheel 5 is fitted around the center boss 3 of the wheel hub 1, the wheel 5 is fixed to the wheel hub 1 so that the wheel 5 may transmit drive power to the wheel hub 1. Furthermore, the center lock bolt 9 is locked in the wheel hub 1 by the latch 11. Accordingly, the mounting state of wheel 5 mounted to the wheel hub 1 may be easily and firmly secured.

In an exemplary embodiment of the present disclosure, accordingly, it may be possible to easily immediately separate the wheel 5 from the wheel hub 1 only through release of the center lock bolt 9 and to firmly fix the wheel 5 to the wheel hub 1 only through fastening of the center lock bolt 9. Thus, the time consumed for replacement of the wheel 5 is very short, and the appearance of the wheel 5 may be configured to be aesthetically pleasing and elegant.

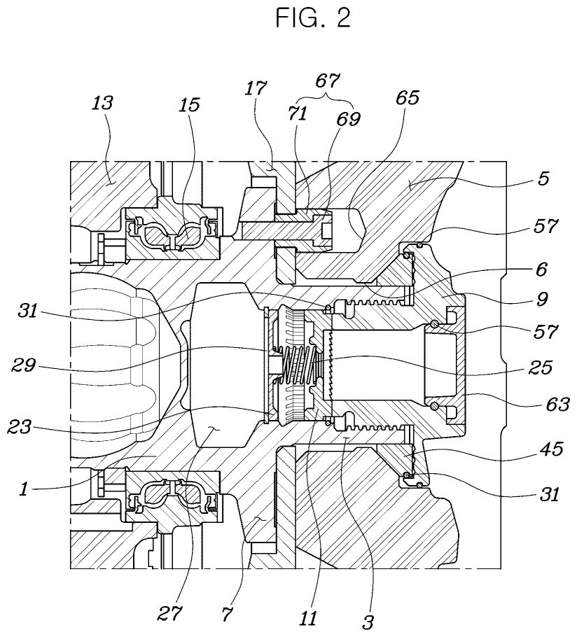

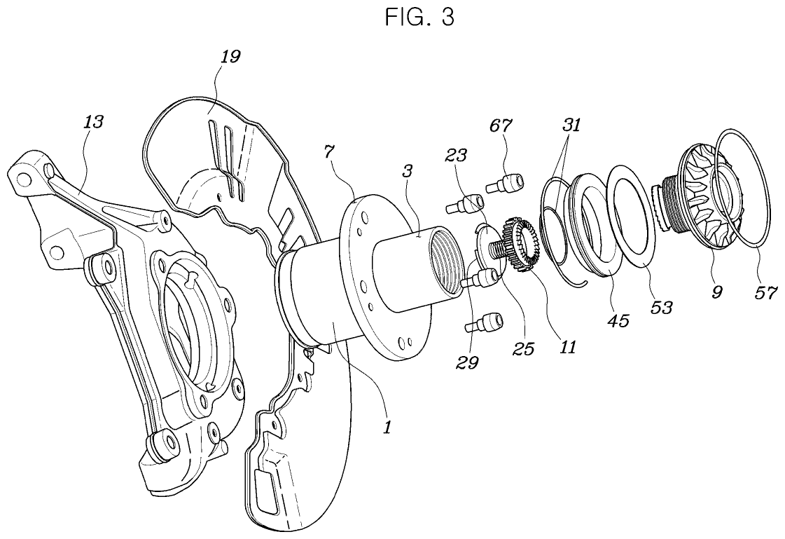

For reference, referring to FIG. 1, FIG. 2, and FIG. 3, the wheel hub 1 is rotatably supported by a knuckle 13 via a wheel bearing 15. A brake disc 17 is mounted at the wheel hub 1, in addition to the wheel 5, to rotate together with the wheel hub 1. A brake disc cover 19 is also shown. The wheel hub 1 is configured to receive rotation force via a constant-velocity joint, etc. not shown, and accordingly, to rotate.

The latch 11 is configured to release a locked state of the center lock bolt 9 by a pressure applied to the latch through the center lock bolt 9.

In the exemplary embodiment of the present disclosure, the latch 11 is mounted at the center boss 3 to be linearly slidable in an axial direction while being prevented from rotating. Furthermore, the latch 11 is supported by the wheel hub 1 while being elastically supported against the center lock bolt 9 in the axial direction.

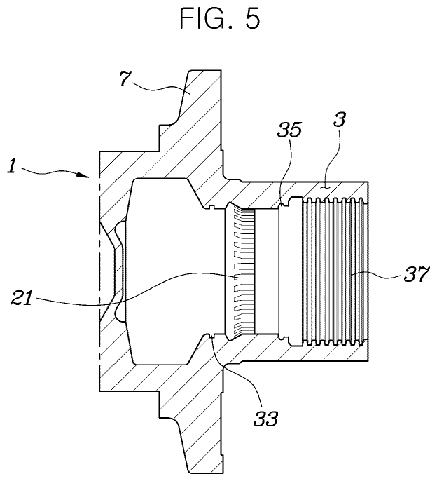

To the present end, as illustrated in FIG. 5, serrations 21 are machined into an internal circumferential surface of the center boss 3 to enable the latch 11 to be linearly slidable in the axial direction.

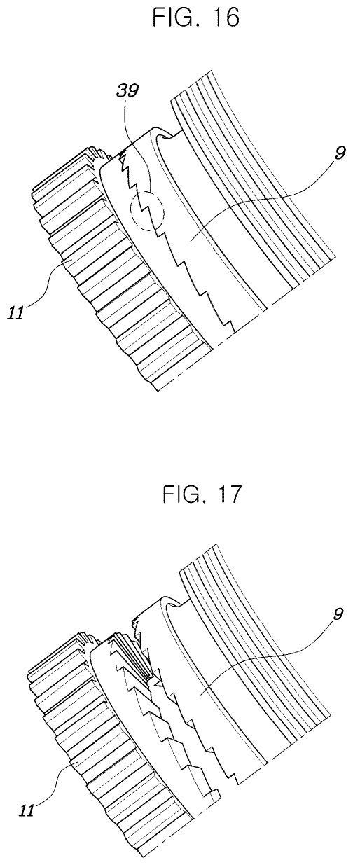

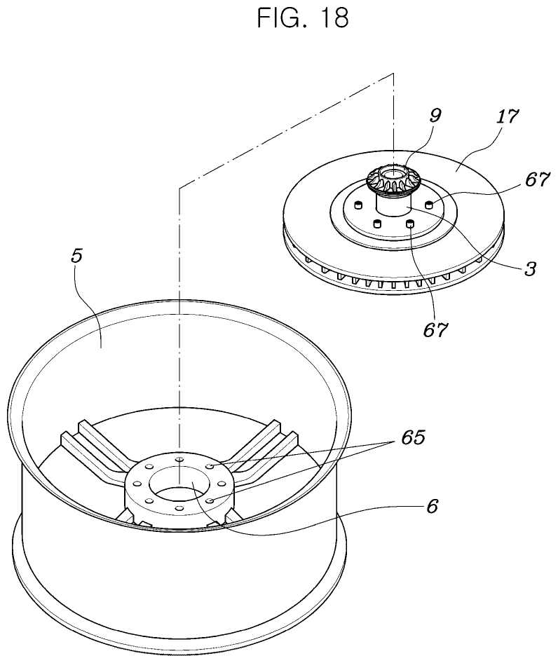

Of course, a structure including grooves and protrusions corresponding to the serrations 21 is formed at a circumferential surface of the latch 11, as shown in FIG. 16 and FIG. 17. Accordingly, since the grooves and protrusions of the latch 11 are engaged to the serrations 21 of the center boss 3, stable and smooth axial linear sliding of the latch 11 within the center boss 3 is secured.

For reference, the “axial direction” means a rotation-axial direction of the wheel hub 1.

A spring seat 23 is provided at the wheel hub 1, and a spring 25 is mounted between the spring seat 23 and the latch 11 to elastically support the latch 11 against the center lock bolt 9.

A hub cavity 27 is formed at the wheel hub 1 to reduce the mass of the wheel hub 1. The spring seat 23 is supported by a snap ring 29 mounted between the hub cavity 27 and the center boss 3.

Of course, in the case in which the hub cavity 27 is not formed at the wheel hub 1 or in the case similar thereto, the spring seat 23 and the snap ring 29 may be omitted.

Furthermore, a circlip 31 may be mounted at the wheel hub 1 to prevent the latch 11 elastically supported by the spring 25 from being separated from the wheel hub 1.

In the exemplary embodiment of the present disclosure, accordingly, the spring 25 is confined in a space between the spring seat 23 supported by the snap ring 29 and the latch 11 supported by the circlip 31, and the latch 11 is maintained in a state of being elastically supported by the circlip 31 without being separated from the wheel hub 1 even in a separated state of the center lock bolt 9. Accordingly, upon replacement of the wheel 5, there may be no inconvenience caused by separate handling of the latch 11, and easy and simple replacement of the wheel 5 may be achieved.

For reference, FIG. 5 shows that a snap ring coupling groove 33 configured to fix the snap ring 29 thereto and a circlip coupling groove 35 configured to fix the circlip 31 thereto are formed under the condition that the serrations 21 are formed therebetween, and bolt fastening threads 37, to which the center lock bolt 9 is fastened, is formed beside the circlip coupling groove 35.

As illustrated in FIG. 7, latch teeth 39 are formed at facing surfaces of the latch 11 and the center lock bolt 9 to allow rotation of the center lock bolt 9 in a fastening direction of the center lock bolt 9 to the center boss 3 while preventing rotation of the center lock bolt 9 in a direction opposite to the fastening direction.

In an exemplary embodiment of the present disclosure, a cross section of the latch teeth 39 may be in a right triangle to allow rotation of the center lock bolt 9 in one direction.

Accordingly, although rotation of the center lock bolt 9 in the direction in which the center lock bolt 9 is fastened to the center boss 3 is freely conducted, rotation of the center lock bolt 9 in the opposite direction is restrained by the latch teeth 39, and accordingly, unfastening of the center lock bolt 9 is prevented unless the latch 11 is released.

Of course, since the latch 11 is maintained in a state of being continuously elastically pressed against the center lock bolt 9 by the spring 25, unfastening of the center lock bolt 9 coupled to the center boss 3 is prevented unless the latch 11 is released by a predetermined tool 41. Consequently, the possibility of separation of the wheel 5 from the wheel hub 1 by itself is completely excluded.

A pressing ring 45 including a wedge-shaped cross-section is mounted between a head flange 43 of the center lock bolt 9 and the wheel 5 to press the wheel 5 against the hub flange 7.

Accordingly, when the center lock bolt 9 is fastened to the center boss 3, the wheel 5 receives a pressure provided by the center lock bolt 9 via the pressing ring 45 without being directly pressed by the center lock bolt 9, and accordingly, is pressed against the hub flange 7.

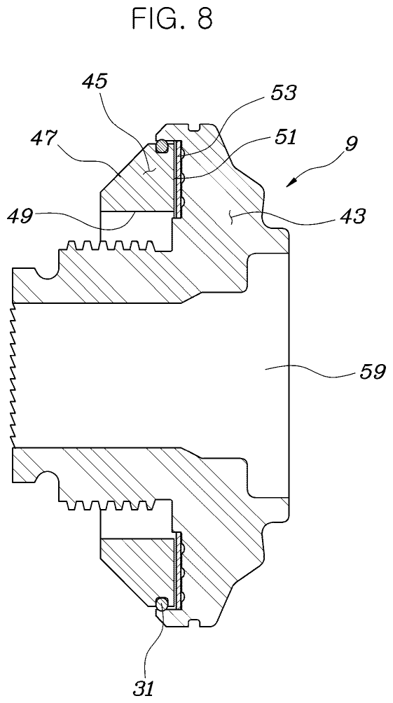

In the exemplary embodiment of the present disclosure, as shown in FIG. 8, the wedge-shaped cross-section of the pressing ring 45 includes an inclined ring surface 47 formed to be inclined with respect to the axial direction to contact with the wheel 5, an internal circumferential ring surface 49 configured to enclose the center boss 3 of the wheel hub 1, and a bolt facing surface 51 formed to be perpendicular to the axial direction so that the bolt facing surface 51 faces the head flange 43 of the center lock bolt 9.

A friction reducing washer 53 is located between the bolt facing surface 51 of the pressing ring 45 and the head flange 43 of the center lock bolt 9 to reduce friction therebetween.

Accordingly, when the center lock bolt 9 is fastened to the center boss 3 so that the pressing ring 45 presses the wheel 5 against the hub flange 7, the inclined ring surface 47 comes into contact with the wheel 5, and the bolt facing surface 51 comes into contact with the friction reducing washer 53.

Since relatively great frictional force is generated between the inclined ring surface 47 of the pressing ring 45 and the wheel 5, no relative rotation is generated between the inclined ring surface 47 and the wheel 5 during rotation of the center rock bolt 9. On the other hand, since relatively small frictional force is generated between the head flange 43 of the center lock bolt 9 and the bolt facing surface 51 of the pressing ring 45, it may be possible to prevent deformation of the wheel 5 and formation of friction marks at the wheel 5 and to reduce a fastening torque of the center lock bolt 9.

Furthermore, at least one friction reducing groove 55 may be formed at the head flange 43 facing the friction reducing washer 53 to reduce an area of the head flange 43 contacting with the friction reducing washer 53. Accordingly, it may be possible to further reduce frictional force between the head flange 43 and the bolt facing surface 51 of the pressing ring 45.

For reference, in FIG. 8, the pressing ring 45 is shown in a state of being fixed to the center lock bolt 9 by the circlip 31 so that the pressing ring 45 is prevented from being separated while being allowed to perform relative rotation.

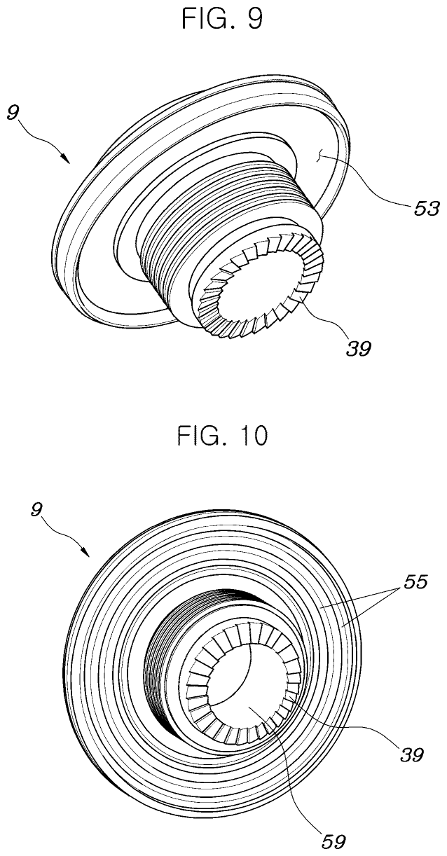

On the other hand, FIG. 9 shows a state in which the pressing ring 45 of FIG. 8 is removed, and the friction reducing washer 53 is still disposed at the head flange 43 of the center lock bolt 9, and FIG. 10 shows a state in which the friction reducing washer 53 is removed, and the friction reducing groove 55 formed at the head flange 43 of the center lock bolt 9 is exposed.

Meanwhile, a seal ring 57 is mounted at a circumferential surface of the head flange 43 of the center lock bolt 9 to form a seal between the head flange 43 and the wheel 5.

That is, when the seal ring 57 is mounted between the head flange 43 and the wheel 5, it is possible to prevent foreign matter from penetrating into a space between the wheel 5 and the center lock bolt 9 in which the pressing ring 45 is accommodated.

Accordingly, the function of a structure configured to generate a frictional force difference between the inclined ring surface 47 and the bolt facing surface 51 of the pressing ring 45 may be stably maintained.

Tool engagement grooves and protrusions 61 are radially regularly formed at the head flange 43 of the center lock bolt 9 in a direction toward the predetermined tool 41 so that the tool engagement grooves and protrusions 61 are formed along a circumference of the head flange 43, to enable the head flange 43 to receive rotation force from the predetermined tool 41 in a state in which the predetermined tool 41 applies a pressure for releasing the latch 11 through a tool insertion hole 59 formed at a center portion of the center lock bolt 9.

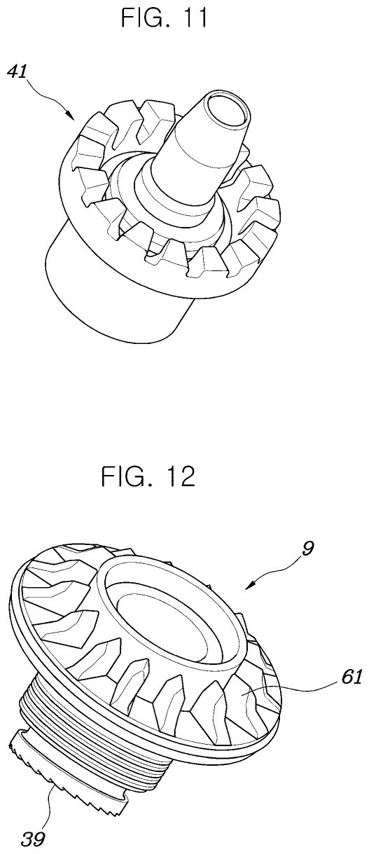

The predetermined tool 41 may include a shape shown in FIG. 11, and the tool engagement grooves and protrusions 61 may include a shape shown in FIG. 12.

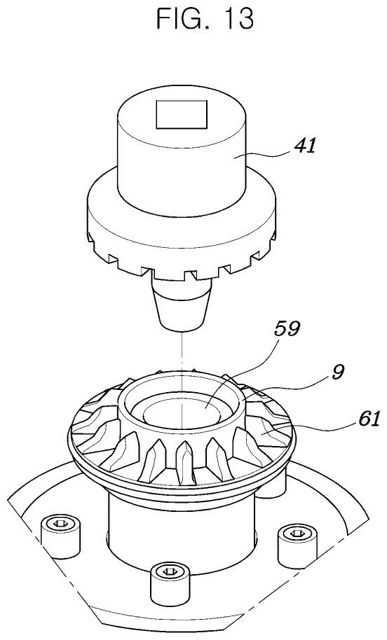

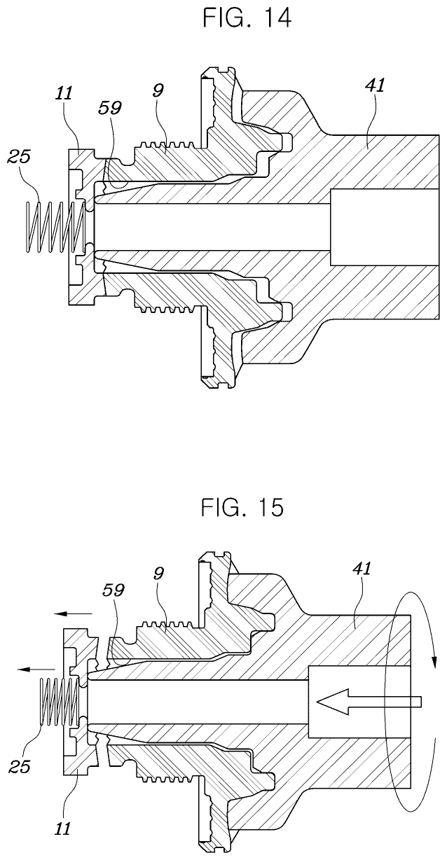

Accordingly, as the predetermined tool 41 moves toward the tool insertion hole 59 and the tool engagement grooves and protrusions 61 of the center lock bolt 9, as shown in FIG. 13, the predetermined tool 41 reaches a position just before a pressing position at which the predetermined tool 41 presses the latch 11, as shown in FIG. 14, and then presses the latch 11 at the pressing position, releasing coupling between the center lock bolt 9 and the latch 11, as shown in FIG. 15.

Accordingly, in the state in which the predetermined tool 41 applies a pressure for releasing the latch 11, the predetermined tool 41 and the center lock bolt 9 are integrally rotatable in accordance with engagement between the predetermined tool 41 and the tool engagement grooves and protrusions 61.

When the predetermined tool 41 is rotated in a direction opposite to the direction in which the center lock bolt 9 is fastened to the center boss 3, the center lock bolt 9 may be separated from the center boss 3.

For reference, FIG. 16 shows a state in which the latch 11 still locks the center lock bolt 9 until the predetermined tool 41 presses the latch 11, whereas FIG. 17 shows a state in which the predetermined tool 41 presses the latch 11, and, accordingly, the latch 11 releases a locked state of the center lock bolt 9.

Meanwhile, a center cap 63 is mounted to the center lock bolt 9 to seal the tool insertion hole 59. Accordingly, it may be possible to prevent external foreign matter or the like from penetrating into an interior of the center boss 3 through the tool insertion hole 59, achieving a more aesthetically pleasing mounting state of the wheel while securing stable operability of the latch 11.

Accordingly, the seal ring 57 is also mounted between the center cap 63 and the center lock bolt 9.

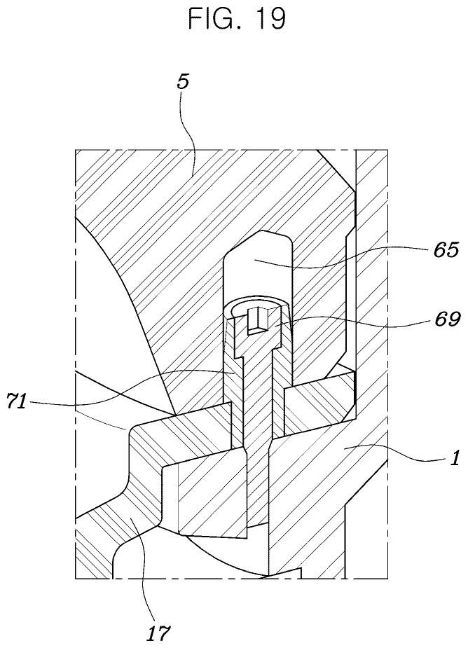

Referring to FIGS. 18 and 19, at least one stud 67 is mounted at the hub flange 7 of the wheel hub 1. The stud 67 protrudes to be inserted into a wheel hub groove 65 of the wheel 5.

Accordingly, relative rotation of the wheel 5 with respect to the wheel hub 1 caused by a torque acting between the wheel 5 and the wheel hub 1 may be structurally prevented. As a result, a firm and stable assembly state between the wheel hub 1 and the wheel 5 may be secured and maintained.

Furthermore, since relative rotation between the wheel hub 1 and the wheel 5 is structurally reliably prevented and the stud 67 neither protrudes from nor is exposed outwardly of the wheel 5 in accordance with insertion of the stud 67 into the wheel hub groove 65, the appearance of the wheel 5 may be greatly enhanced.

The stud 67 may include a stud bolt 69 fastened to the hub flange 7, and a stud sleeve 71 formed to contact with the wheel hub groove 65 and to allow the stud bolt 69 to extend therethrough. The stud sleeve 71 may be formed of a material different from that of the stud bolt 69.

For example, the stud bolt 69 may be made of a steel material, and the stud sleeve 71 may be made of aluminum, an aluminum alloy, or the like.

The stud sleeve 71, which is made of an aluminum alloy, as described above, may provide thermal expansion characteristics similar to those of the wheel 5 made of a material identical or similar to the aluminum alloy, even for a thermal load transmitted thereto from the brake disc 17 in a state in which the stud sleeve 71 is inserted into the wheel 5. Accordingly, a firm and stable assembly state between the wheel 5 and the stud 67 may be maintained.

Referring to FIG. 19, the brake disc 17 is mounted between the wheel hub 1 and the wheel 5, and the stud sleeve 71 has a greater diameter at a portion thereof inserted into the wheel hub groove 65 than at a portion thereof extending through the brake disc 17, to press the brake disc 17 against the wheel hub 1 by a pressure applied by the stud bolt 69, fixing the brake disc 17 to the wheel hub 1.

Accordingly, even when the wheel 5 is in a state of being separated from the wheel hub 1 in accordance with removal of the center lock bolt 9 from the center boss 3, the state of the brake disc 17 fixed to the wheel hub 1 may be stably maintained by the stud sleeve 71.

Meanwhile, a wheel hub assembly used in the above-described wheel mounting structure for a vehicle according to an exemplary embodiment of the present disclosure includes a hub flange 7 configured to form a flat surface perpendicular to an axial direction, a center boss 3 protruding from the hub flange 7 in the axial direction, a center lock bolt 9 fastened to the center boss 3 and configured to press, against the hub flange 7, an internal diameter portion 6 of a wheel 5 fitted around the center boss 3, and a latch 11 configured to be linearly slidable in the axial direction within the center boss 3 while being prevented from rotating, to lock the center lock bolt 9 for prevention of rotation of the center lock bolt 9 with respect to the center boss 3.

At least one stud 67 protruding in the axial direction is mounted at the hub flange 7, and the latch 11 is configured to release a locked state of the center lock bolt 9 by axial pressure of a tool inserted into the center lock bolt 9 through a center portion of the center lock bolt 9.

Meanwhile, a wheel for a vehicle used in the above-described wheel mounting structure for a vehicle according to an exemplary embodiment of the present disclosure includes an internal diameter portion configured to be fitted around a center boss 3 protruding along a rotation center of a hub flange 7 in an axial direction, to couple the wheel to a wheel hub 1 including the center boss 3, the wheel hub 1 further including a stud 67 configured to be spaced apart from the center boss 3 while protruding from the hub flange 7 in the axial direction. The wheel further includes a wheel hub groove 65 provided at an area surrounding the internal diameter portion 6 to receive the stud 67. The area surrounding the internal diameter portion 6 is formed to be pressed against the hub flange 7 by a center lock bolt 9 coupled to the center boss 3.

As apparent from the above description, the present disclosure provides a wheel mounting structure for a vehicle which is capable of greatly reducing a wheel replacement time and effectively preventing theft of a wheel while being advantageous in terms of formation of an aesthetically pleasing and elegant wheel appearance.

Effects attainable in an exemplary embodiment of the present disclosure are not limited to the above-described effects, and other effects of the present disclosure not yet described will be more clearly understood by those skilled in the art from the above-described detailed description.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “or” used in an exemplary embodiment of the present disclosure should be interpreted as indicating “additionally or alternatively.”The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

The terms used to describe the exemplary embodiments are used for describing predetermined embodiments, and are not intended to limit the embodiments. As used in the description of the exemplary embodiments and in the claims, the singular forms “a”, “an”, and “the” include plural referents unless the context clearly dictates otherwise. The expression “and/or”is used to include all possible combinations of terms.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

As used herein, conditional expressions such as “if” and “when” are not limited to an optional case and are intended to be interpreted, when a specific condition is satisfied, to perform the related operation or interpret the related definition according to the specific condition.

Terms such as first and second may be used to describe various elements of the embodiments. However, various components according to the embodiments should not be limited by the above terms. These terms are only used to distinguish one element from another.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain predetermined principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A wheel mounting structure for a vehicle, the wheel mounting structure comprising:
a wheel hub;
a wheel fitted around a center boss of the wheel hub at an internal diameter portion of the wheel;
a center lock bolt coupled to the center boss and configured to press the internal diameter portion of the wheel against a hub flange of the wheel hub; and
a latch mounted between the center lock bolt and the center boss and configured to lock the center lock bolt in the center boss.

2. The wheel mounting structure of claim 1, wherein the latch is configured to release a locked state of the center lock bolt by a pressure applied to the latch through the center lock bolt.

3. The wheel mounting structure of claim 2, wherein the latch is mounted at the center boss to be linearly slidable in an axial direction while being prevented from rotating, and is supported by the wheel hub while being elastically supported against the center lock bolt in the axial direction.

4. The wheel mounting structure of claim 3, wherein latch teeth are formed at facing surfaces of the latch and the center lock bolt to allow rotation of the center lock bolt in a fastening direction of the center lock bolt to the center boss while preventing rotation of the center lock bolt in a direction opposite to the fastening direction.

5. The wheel mounting structure of claim 3,
wherein a spring seat is provided at the wheel hub, and
wherein a spring is mounted between the spring seat and the latch to elastically support the latch against the center lock bolt.

6. The wheel mounting structure of claim 5,
wherein a hub cavity is formed at the wheel hub to reduce a mass of the wheel hub, and
wherein the spring seat is supported by a snap ring mounted between the hub cavity and the center boss.

7. The wheel mounting structure of claim 6, wherein a circlip is mounted at the wheel hub to prevent the latch elastically supported by the spring from being separated from the wheel hub.

8. The wheel mounting structure of claim 7,
wherein serrations are formed at an internal circumferential surface of the center boss to guide axial linear movement of the latch,
wherein a snap ring coupling groove configured to fix the snap ring to the snap ring coupling groove and a circlip coupling groove configured to fix the circlip to the circlip coupling groove are formed at the wheel hub, and
wherein the snap ring coupling groove and the circlip coupling groove are disposed under a condition that the serrations are disposed between the snap ring coupling groove and the circlip coupling groove.

9. The wheel mounting structure of claim 3,
wherein serrations are formed at an internal circumferential surface of the center boss to guide axial linear movement of the latch, and
wherein a structure including grooves and protrusions corresponding to the serrations is formed at a circumferential surface of the latch and engaged to the serrations of the center boss.

10. The wheel mounting structure of claim 2,
wherein a pressing ring including a wedge-shaped cross-section is mounted between a head flange of the center lock bolt and the wheel to press the wheel against the hub flange, and
wherein the wedge-shaped cross-section of the pressing ring includes an inclined ring surface formed to be inclined with respect to the axial direction to contact with the wheel, an internal circumferential ring surface configured to enclose the center boss of the wheel hub, and a bolt facing surface formed to be perpendicular to the axial direction so that the bolt facing surface faces the head flange of the center lock bolt.

11. The wheel mounting structure of claim 10, wherein a friction reducing washer is mounted between the bolt facing surface of the pressing ring and the head flange of the center lock bolt to reduce friction therebetween.

12. The wheel mounting structure of claim 11, wherein at least one friction reducing groove is formed at the head flange facing the friction reducing washer to reduce an area of the head flange contacting with the friction reducing washer.

13. The wheel mounting structure of claim 10, wherein a seal ring is mounted at a circumferential surface of the head flange of the center lock bolt to form a seal between the head flange and the wheel.

14. The wheel mounting structure of claim 10, wherein tool engagement grooves and protrusions are radially regularly formed at the head flange of the center lock bolt in a direction toward a predetermined tool so that the tool engagement grooves and protrusions are disposed along a circumference of the head flange, to enable the head flange to receive rotation force from the predetermined tool in a state in which the predetermined tool applies a pressure for releasing the latch through a tool insertion hole formed at a center portion of the center lock bolt.

15. The wheel mounting structure of claim 14, wherein a center cap is mounted to the center lock bolt to seal the tool insertion hole.

16. The wheel mounting structure of claim 14,
wherein the predetermined tool and the center lock bolt are configured to be integrally rotatable in accordance with engagement between the predetermined tool and the tool engagement grooves and protrusions in the state in which the predetermined tool applies the pressure for releasing the latch, and
wherein the center lock bolt is separated from the center boss based on that the predetermined tool is rotated in a direction opposite to a fastening direction of the center lock bolt to the center boss.

17. The wheel mounting structure of claim 2,
wherein at least one stud is mounted at the hub flange of the wheel hub while protruding to be inserted into a wheel hub groove of the wheel,
wherein the at least one stud includes:
a stud bolt fastened to the hub flange; and
a stud sleeve formed to contact with the wheel hub groove and to allow the stud bolt to extend through the stud sleeve, the stud sleeve being formed of a material different from a material of the stud bolt,
wherein a brake disc is mounted between the wheel hub and the wheel, and
wherein the stud sleeve has a greater diameter at a portion thereof inserted into the wheel hub groove than at a portion thereof extending through the brake disc, to press the brake disc against the wheel hub by a pressure applied by the stud bolt, for fixing the brake disc to the wheel hub.

18. A wheel hub assembly for a vehicle, the wheel hub assembly comprising:
a hub flange including a flat surface perpendicular to an axial direction;
a center boss protruding from the hub flange in the axial direction;
a center lock bolt fastened to the center boss and configured to press, against the hub flange, an internal diameter portion of a wheel fitted around the center boss; and
a latch mounted between the center lock bolt and the center boss and configured to be linearly slidable in the axial direction within the center boss while being prevented from rotating, to lock the center lock bolt for prevention of rotation of the center lock bolt with respect to the center boss.

19. The wheel hub assembly of claim 18,
wherein at least one stud protruding in the axial direction is mounted at the hub flange, and
wherein the latch is configured to release a locked state of the center lock bolt by an axial pressure of a tool inserted into the center lock bolt through a center portion of the center lock bolt.

20. A wheel for a vehicle, the wheel comprising:
an internal diameter portion configured to be fitted around a center boss protruding along a rotation center of a hub flange in an axial direction, to couple the wheel to a wheel hub including the center boss, the wheel hub further including a stud spaced apart from the center boss while protruding from the hub flange in the axial direction; and
a wheel hub groove formed at an area surrounding the internal diameter portion to receive the stud therein,
wherein the area surrounding the internal diameter portion is configured to be pressed against the hub flange by a center lock bolt coupled to the center boss.
